(19) United States
(12) Patent Application Publication
(10) Pub. No.: US 2004/0203787 A1
(43) Pub. Date: Oct. 14, 2004

(54) System and method for reverse handover in mobile mesh Ad-Hoc networks

(76) Inventor: Siamak Naghian, Espoo (FI)

Correspondence Address: DARBY & DARBY P.C., P.O. BOX 5257, NEW YORK, NY, 10150-6257, US

(21) Appl. No.: 10/186,199

(22) Filed: Jun. 28, 2002

(51) Int. Cl. H04Q 7/20

(52) U.S. Cl. 455/437; 370/358; 455/41.1

(57) ABSTRACT

A method is provided for solving the mobility of a mobile trunk node (MTN) within an operated assisted mobile mesh local Ad-Hoc network. The method provides a reverse handover (RHO) when there exists another node within the local Ad-Hoc network, which is able to assume the logical role of a MTN. Before the first MTN performs the handover, existence of the other suitable MTN is determined. Where a suitable MTN is determined, the MTN functions are transferred to the new MTN before handover of the first MTN to a new cell of a cellular-based network. Upon transfer of the MTN functions to the new MTN, Ad-Hoc traffic is relayed to and from the local Ad-Hoc network via the new MTN. Enhanced tunneling is proposed to minimize network traffic delays during the handover. The reverse handover also enables the first MTN to preserve its original merely Ad-Hoc local network connection.

### FIELD OF THE INVENTION

The present invention relates to wireless networks, and more particularly to reverse handovers in mobile mesh for Ad-Hoc networking in an operator assisted mobile mesh Ad-Hoc (OAM) network.

### BACKGROUND OF THE INVENTION

The recent evolution of radio and mobile computing technologies has enabled the development of ubiquitous wireless computing services, which provide a mobile user with voice, data, and multimedia services virtually at any time, any place, and in any format. Just how popular wireless communication has become in less than a decade can be attested to by the size of the market, as well as the capitalization, and the penetration of wireless technologies worldwide. However, in spite of its recent growth, wireless communications is still in its infancy.

Although still in its infancy, mobile users' expect high quality services from their wireless infrastructures. Such expectations result in numerous problems for mobile management connectivity. For example, today's mobile users create Ad-Hoc networks that allow members to move randomly, connecting, disconnecting, and generally re-organizing themselves in an arbitrary fashion. This results in rapid and unpredictable changes in the underlying Ad-Hoc's topology, and associated signal connectivity. Moreover, mobile users within such Ad-Hoc networks also expect to be able to communicate with ground-based networks, obtaining operator assisted services, and Internet accesses, further increasing the complexity of managing mobile connectivity.

While mobile users' expectations are high, numerous problems remain in maintaining the various wireless connections as nodes move into and out of such Ad-Hoc configurations. Thus, it is with respect to these considerations and others that the present invention has been made.

### SUMMARY OF THE INVENTION

This summary of the invention section is intended to introduce the reader to aspects of the invention. Particular aspects of the invention are pointed out in other sections herein below, and the invention is set forth in the appended claims, which alone demarcate its scope.

The present invention provides a system and method for solving the mobility of a mobile trunk node (MTN) within an operator assisted mobile mesh local Ad-Hoc network.

According to one aspect of the invention, a system is directed toward handovers in a mobile network that include an access domain, ad-hoc domain and a backbone domain. The ad-hoc domain is in communication with the access domain and enables wireless communication with a first node operating as a mobile trunk node in the ad-hoc domain. A first access connection in the access domain enables wireless communication between the mobile trunk node and the access domain, wherein the mobile trunk node enables other nodes in the ad-hoc domain to wirelessly communicate with the access domain. However, if the first node leaves the ad-hoc domain, the operation of the mobile trunk node is handed over to a second node in the ad-hoc domain. By operating as the mobile trunk node, the second node employs the first access connection to communicate with the access domain and enable the remaining nodes in the ad-hoc domain to wirelessly communicate with the access domain. A second access connection may be employed to enable the first node to wirelessly communicate with nodes operating in the ad-hoc domain. After the handover, communication between the first node and the ad-hoc domain may be implemented by tunneling a communication path between the second access connection and the first access connection in the access domain. Alternatively, the communication between the first node and the ad-hoc domain may be implemented using the ad-hoc domain, where tunneling may be employed. Further, the communication between the first node and the ad-hoc domain may even be implemented using a route over the backbone domain, in which communication tunneling may also be advantageously employed.

Another aspect of the invention is directed to enabling the second node in the ad-hoc domain to operate as the mobile trunk node based on a set of criteria, including at least one of location coordinates, movement characteristics of the nodes, number of hops, handover capability, service profile, service availability, Quality of Service, power level, routing metrics, accounting policy, billing policy and inclusion of an identifier module in the node.

Yet another aspect of the invention is directed to enabling at least a portion of the backbone domain to include an Internet infrastructure. Also, the access domain can include at least one of a mesh network, Wireless Local Area Network (WLAN) and cellular network. Additionally, at least one of the first access connection and the second access connection operates as a base station or an access router.

Still another aspect of the invention is directed to at least one of the first access connection and the second access connection operating as an access point. Also, another aspect of the invention is directed to employing an operator-assisted connection to communicate between the ad-hoc domain and the access domain. Additionally, a handover criteria may be employed to determine if the first node is leaving the ad-hoc domain, including at least one of service profile, service availability, Quality of Service, power level, routing metric, signal quality and noise level.

In accordance with yet another aspect of the invention, an apparatus, method and computer readable medium may be employed to practice substantially the same actions discussed above.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates a functional block diagram of one embodiment of a general architecture of a mobile mesh Ad-Hoc network;

FIG. 2 illustrates a functional block diagram of one embodiment of a mobile mesh Ad-Hoc network of FIG. 1 employing a Mobile Trunk Node;

FIG. 3 illustrates a functional block diagram generally showing one embodiment of the mobile mesh Ad-Hoc network of FIG. 2 wherein the original Mobile Trunk Node has completed a reverse handover to a new Mobile Trunk Node;

FIG. 4 is a flow diagram generally showing one embodiment of a reverse handover adopted for IPv6 networks; and

FIG. 5 is a signaling sequence diagram generally showing one embodiment of a reverse handover; in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise.

The term “Ad-Hoc Network” means a network structure that is temporary and its configuration is performed automatically and constantly because nodes may appear, disappear, and move unexpectedly. An Ad-Hoc Network can be based on single hop or/and multihop radio or other wireless links, such as infrared links.

The term “AirHead” means a default router in mesh network that acts as an access point (AP). The term “macromobility” refers to an approach to handle the mobility between network segments or different networks.

The term “mesh” means a multipoint-to-multipoint network topology.

The term “micromobility” refers to an approach to handle the mobility inside a mesh network due to the changes in the network topology.

The term “mobile mesh” means a multipoint-to-multipoint network topology, in which mobile nodes may appear/disappear randomly and establish/terminate radio links to/from their geographical neighbor nodes.

The term “multihop” means that communication happens via intermediate/relaying nodes.

The term “peer to peer” means direct communication between network terminals, which can be either single hop or multihop.

The term “node” refers to a node on a network.

The terms “mobile node, mobile device, and terminal” refer to a node on the network that is mobile.

The term “flow” means a flow of packets. The term “Trunk Node” (TN) refers to a node (i.e. a mobile node or a wireless router) that acts as a gateway between an access domain (e.g. WLAN, cellular, mesh) and the “child” terminals of the corresponding Ad-Hoc network.

The term “Ad-Hoc cell” refers to the area within Ad-Hoc domain, which comprises all child nodes with a distance less or equal to N hops from the Trunk Node and identified by an ID or its geographical coordinates.

The term “operator” refers to any technician or organization that maintains or services an IP based network.

The term “identifier” includes a Mobile Station Integrated Services Digital Network (MSISDN) number, an IP address, or any other information that relates to the location or identity of the user. Additionally, a reference to the singular includes a reference to the plural unless otherwise stated or is inconsistent with the disclosure herein.

Briefly stated, the present invention provides a system and method for handovers of a Mobile Trunk Node's (MTN) logical functionality within an operator assisted mobile mesh Ad-Hoc (OAM) network. The system and method employs a reverse handover (RHO) approach to transition the MTN's logical functionality to an eligible node within the OAM network when the original MTN is about to leave the OAM network. Upon successful completion of the RHO, the original MTN remains in communication with the OAM network, through an access domain network, such as a cellular network, through a backbone network connection, such as an internet connection or through an Ad-Hoc connection. Delays in network traffic are reduced by enhanced tunneling.

Illustrative Environment

Ad-Hoc networks may be classified into at least three categories based on its infrastructure. One category includes infrastructureless Ad-Hoc networks, wherein the Ad-Hoc network may operate in a stand-alone configuration without an access point (AP). A second category includes infrastrure-based Ad-Hoc networks; such as cellular and fixed-wireless mesh networks. The third category of Ad-Hoc networks includes hybrid configurations that employ a combination of the first two categories. Hybrid Ad-Hoc networks include configurations such as operator assisted mobile mesh Ad-Hoc (OAM) networks, where trunk nodes within the Ad-Hoc network enable communications to operator assisted access points that bridge a gap between the Ad-Hoc wireless network and a wired network.

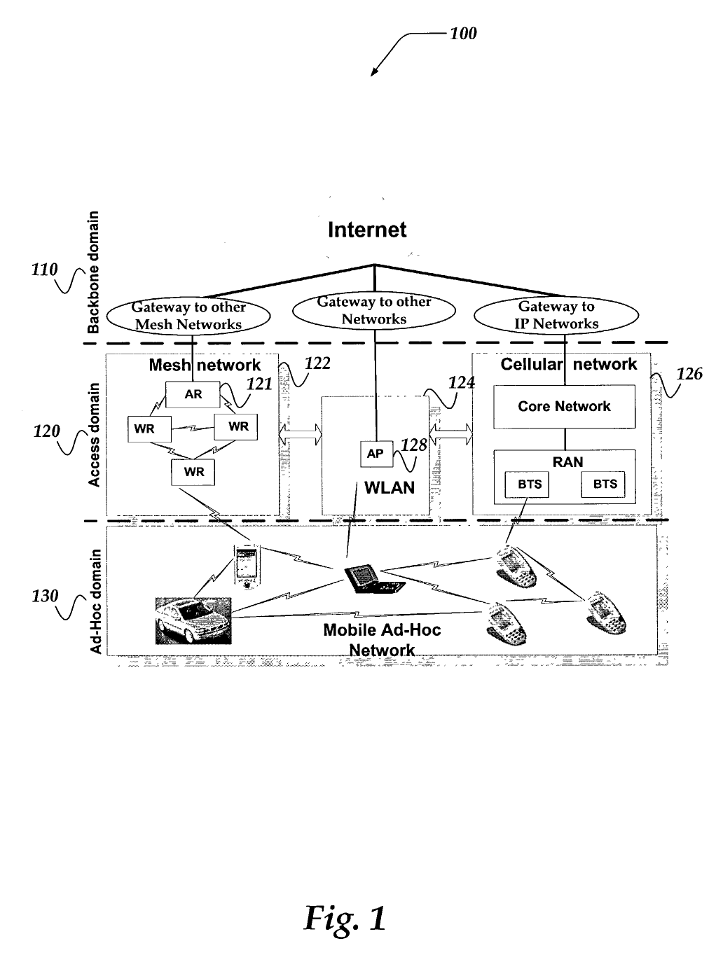

FIG. 1 illustrates a functional block diagram of a general architecture of a mobile mesh Ad-Hoc network, in accordance with aspects of the invention. Mobile mesh Ad-Hoc network 100 represents one embodiment of a hybrid Ad-Hoc network.

As shown in the figure, mobile mesh Ad-Hoc network 100 includes three architectural hierarchies: backbone network 110, such as the Internet, access domain 120, and Ad-Hoc domain 130. According to one embodiment of the invention, the Internet infrastructure is employed as backbone network 110.

Access domain 120 is described in more detail below. Briefly, however, access domain 120 includes a variety of radio access networks that overlay stand-alone Ad-Hoc networks, providing infrastructure-oriented radio connection for the subscriber node. Access domain 120 may include more radio access networks than those shown. As illustrated in FIG. 1, access network 120 includes mesh network 122, WLAN network 124, and cellular network 126, each of which is described in more detail below.

Ad-Hoc domain 130 is an actual Ad-Hoc network basis, which provides peer-to-peer single-hop, multi-hop and multi-branch radio communication; including both, infrastructure-less and infrastructure-oriented radio communication for the subscriber node. Ad-Hoc domain 130 is described in more detail below.

In principle, and depending on the presence of the access networks, overlaying the Ad-Hoc network, the subscriber node can communicate either with single radio access, multi-radio accesses, establish only peer-to-peer Ad-Hoc connection or make any combination of them. In this regard, the infrastructure networks are established to provide wireless subscriber node with specific services and range extension.

Ad-Hoc Domain 130

A mobile Ad-Hoc network can be seen as an autonomous system of terminal routers and related hosts connected by wireless radio links. As the terminal routers can move freely and randomly and organize themselves arbitrarily, the network's topology may change rapidly. Ad-Hoc domain 130 may also include a plurality of fixed nodes enabled to route a data packet when needed. It is also possible that an Ad-Hoc terminal is not capable of signal routing (single hop) or otherwise can be able to cease its routing in association with some circumstances e.g. for lack of power.

Depending on the utilized mesh extension, the network topology may be relied on single hop or multihop radio connection. In principle, and due to its nature, standalone Ad-Hoc networks can act independent of any operator or service provider. Ad-Hoc domain 130 may include 1 to N clusters of Ad-Hoc terminals forming Ad-Hoc sub networks or cells, although only one network has been illustrated.

Each Ad-Hoc cell may have at least one terminal as the Trunk Node (TN). The Trunk Node acts as a gateway between access network 120 (e.g. mesh 122, WLAN 124, and cellular 126) and the “child” terminals of that cell e.g. in association with control signaling between the backbone network(s) and the Ad-Hoc network. The Trunk Node can be seen as a logical role whose functions and physical location can vary based on case-specific manner and the criteria such as location coordinates and vicinity to the Access Point (AP), movement characteristics of the Ad-Hoc network nodes, number of hops, handover capability, service profile and service availability, Quality of Services, power level, routing metrics, charging policy, Subscriber Identity Module (SIM/ID) when handling the control functions between the overlaid network(s) and Ad-Hoc terminals (child entities), et cetera. Moreover, the Trunk Node may act as a gateway, providing operator assisted or service provider services to the nodes within Ad-Hoc domain 130. The range of the Ad-Hoc network depends upon the utilized mesh/link technology.

Access domain 120

As shown in FIG. 1, Access Domain 120 includes a plurality of radio access technologies combined in various layouts, configurations, and architecture hierarchies. Based on current access technologies, the most potential components of access domain 120 include 2^{nd} (2G) and 3^{rd} (3G) generation radio access for cellular systems, Wireless LAN, Wireless Router (WR) mesh, and the like. Overviews of these are described below. Access domain 120 is capable of transferring multihop traffic, which means traffic from Ad-Hoc nodes behind a node connected to Access domain 120. In addition, it supports context transfer of authentication for Ad-Hoc nodes moving between single hop and multihop connections. Therefore, authentication, authorization and accounting network entities supporting the underlying Ad-Hoc network may, physically, be part of the corresponding elements in the current infrastructure of cellular access networks and each Ad-Hoc node connected by single or multiple hops to the network can individually authenticate to subscriber control elements.

Mesh Network 122

A wireless router (WR) may be employed as a building block of mesh network 122 access architecture. Principally, WR-based mesh network 122 mirrors the structure of the wired Internet. The WR solution uses a wireless operating system that automatically routes traffic through the network in a multipoint-to-multipoint pattern. A master element of mesh network 122 is AirHead 121. Internet access is established with the deployment of an access router AirHead 121 connected to a wired or wireless backhaul. Subscriber routers are deployed throughout the coverage area of AirHead 121. Each subscriber router not only provides access for attached users, but also becomes part of the network infrastructure by routing traffic through the network over multiple hops. This allows users to join the network even if they are out of range of AirHead 121.

Wireless LAN (WLAN) network 124

As seen in FIG. 1, WLAN network 124 includes Access Point (AP) 128 and a group of terminals that are under the direct control of the AP, forming a Basic Service Set (BSS) as the fundamental building block of the access network. AP 128 forms a bridge between wireless and wired LANs while being the master for the network. AP 128 is analogous to a base station (BS) in cellular phone networks. All communications between terminals or between a terminal and a wired network client go through the AP 128. AP 128 is not planned to be mobile, instead forming part of the wired network infrastructure. Mobile nodes can roam between several APs and therefore seamless campus-wide coverage is possible. A wireless LAN network in this configuration is said to be operating in the infrastructure mode. Some WLAN devices support also peer-to-peer communication even inside infrastructure network.

Cellular Network 126

Radio Accesses of 2^{nd}_{,} 3^{rd} generation and also future cellular networks provide wide area coverage for mobile devices with various degree of mobility. In the case of a multimode Ad-Hoc terminal, the terminal can have radio connection through the radio network accesses such as Global System for Mobile communication (GSM) BSS, including General Packet Radio Service (GPRS) and Enhanced Data GSM Environment (EDGE), and Wideband Code Division Multiple Access (WCDMA). In this respect, the Ad-Hoc terminal acts as a conventional GSM or WCDMA terminal in addition to those features supported for Ad-Hoc purposes. The Radio Access Network (RAN) includes a group of access routers and base stations (AR/BS) within a base transceiver station (BTS). RAN is responsible for handling radio resource management (RRM), handling the overall control of radio connection, radio transmission, and many other functions specified in the corresponding standards for radio access systems. Cellular network 126 may also coordinate the radio resource of the trunk node as far as the traffic relaying over cellular network is concerned, enabling operator assisted mobile mesh (OAM) communications.

Trunk Node Mobility Management

From a network architecture viewpoint, there are different handover situations that may arise when deploying the hybrid mobile mesh Ad-Hoc network of FIG. 1.

In the situation where a Mobile Trunk Node (MTN) moves within a single Access Router (AR)/Base Station (BS), or Access Point (AP) coverage, the trunk node connectivity with respect to the infrastructure network typically is not affected. Hence, the MTN mobility may be handled by routing and link layer mechanisms, employing link-local (for single hop communications), site-local (for multihop communications within the local Ad-Hoc network under the same AR/BS, network prefix, and IP address, in conjunction with Router Advertisement and Router Solicitation procedures. Thus, an Intra AR/BS (or Intra Local Ad-Hoc cell) handover for MTN may be practically handled with routing and link layer protocols by employing site-local (address and other access point information) or/and link-local addresses, as long as there is ongoing Ad-Hoc level communications. The IP address is employed when there is data communicated with the backbone network. Moreover, those node, which are able to handle the MTN logical role need to have the capability of being globally reachable (have a global IP address) with backbone/Internet access. Alternatively, other nodes (non-MTN such as a camera, Personal Digital Assistant, sensor devices, etc.) need not have access to the backbone/Internet. In addition, if the role of the MTN needs to be transferred to another node due to signal quality, battery life of current MTN or the like, then it may be accomplished in cooperation with the access domain network associated with the connection.

The Mobile Trunk Node (MTN) or the first node in the local Ad-Hoc network may establish the site-local prefix, at the time of establishing the Ad-Hoc network using a site-local address to communicate inside the local Ad-Hoc network, under the same AR/BS. This may be achieved by employing a traditional site-local discovery procedure and multicasting the Router Solicitation and Routing Advertisement to other nodes within the local Ad-Hoc network.

A Trunk Node may also move between different radio systems such as Wireless LAN, GSM/BSS, WCDMA/UTRAN, WCDMA/IMT2000, Wireless Router Network, a satellite system, or the like. In these “Inter-system MTN handover” situations, connectivity may, in addition to this invention, be addressed by employing mobile IP macromobility, and traditional or enhanced handover approaches within in Radio Resource Management of each radio access network.

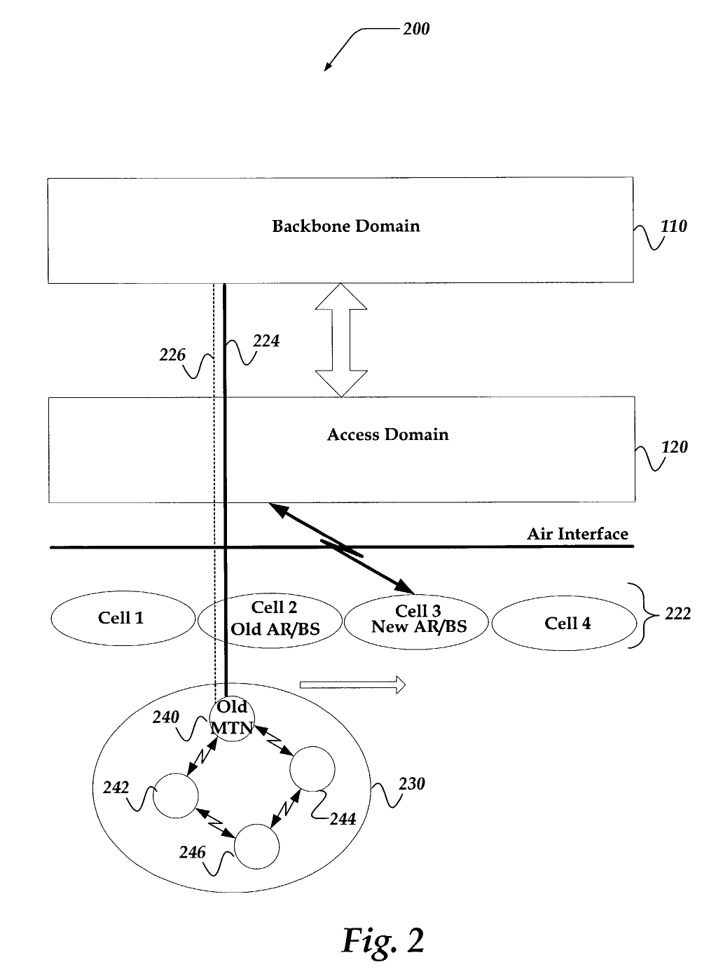

In yet another situation, MTNs may move between Access Points or Base Stations. This “Inter AR/BS Handover” is described as a more detailed example below in conjunction with FIGS. 2-5, and is one exemplary illustration of the subject of the present invention.

Both Inter-system MTN handovers and Inter AR/BS Handover are the subject of the present invention, and equally applicable to the principles of the invention. Substantially the same principles according to this invention may be employed either within a single radio system in the access domain or between different radio systems, i.e. in a situation where the cells participating the handover belong to different access domains. In the illustrations described in FIGS. 2-5, the invention is described by an example of an Inter ARIBS handover in which the related Access Points or Base Stations pertain to a single radio system (access domain). This implies that the connection between the old MTN and the ad-hoc domain, after a successful MTN handover, may be implemented using either an ad-hoc connection, where MTN role is changed into a non-Trunk Node for the ad hoc domain, but the connection remains, or it may be implemented over the access domain. In addition to the above-described handover situations, arising from MTN mobility, there are also handover situations that arise due to the movement of the MTN and its relation to a connected Non-Trunk Nodes (NTN). Thus, virtually any terminal node behind the trunk node connection may be affected by mobility.

Whenever an Ad-Hoc network's internal topology changes, rerouting may be needed. Such situations may arise when a Non-Trunk Node moves just inside the Ad-Hoc network, without any connectivity to an access domain, or when a Non-Trunk Node moves behind one stationary Trunk Node. It may also arise when a Non-Trunk Node moves between a Trunk Node associated with a Base Station.

In addition, situations may arise that necessitate a Mobile IP handover. That is, a new Care of Address (CoA) and a binding update (with tunneling) may be needed. Such situations may arise when a Non-Trunk Node moves between Trunk Nodes of different Base Stations of the same Base Station Subsystem. A Mobile IP handover situation may also arise when a Non-Trunk Node moves between Trunk Nodes of different Base Stations of different Base Station Subsystems (e.g., Wireless LAN, WCDMA, GSM, IMT, and the like). Similarly, such situations may arise when a Non-Trunk Node moves together with a mobile Trunk Node, between different Base Stations of the same Base Station Subsystem; or when a Non-Trunk Node moves together with a mobile Trunk Node between different Base Stations of a different Base Station Subsystem; or when a Non-Trunk Node logical role is interchanged with a Trunk Node role.

Finally, in the situation where a Non-Trunk Node moves together with a mobile Trunk Node within the coverage of one Base Station, the Non-Trunk Node may not be aware of the change of radio systems, without a notification from the Trunk Node.

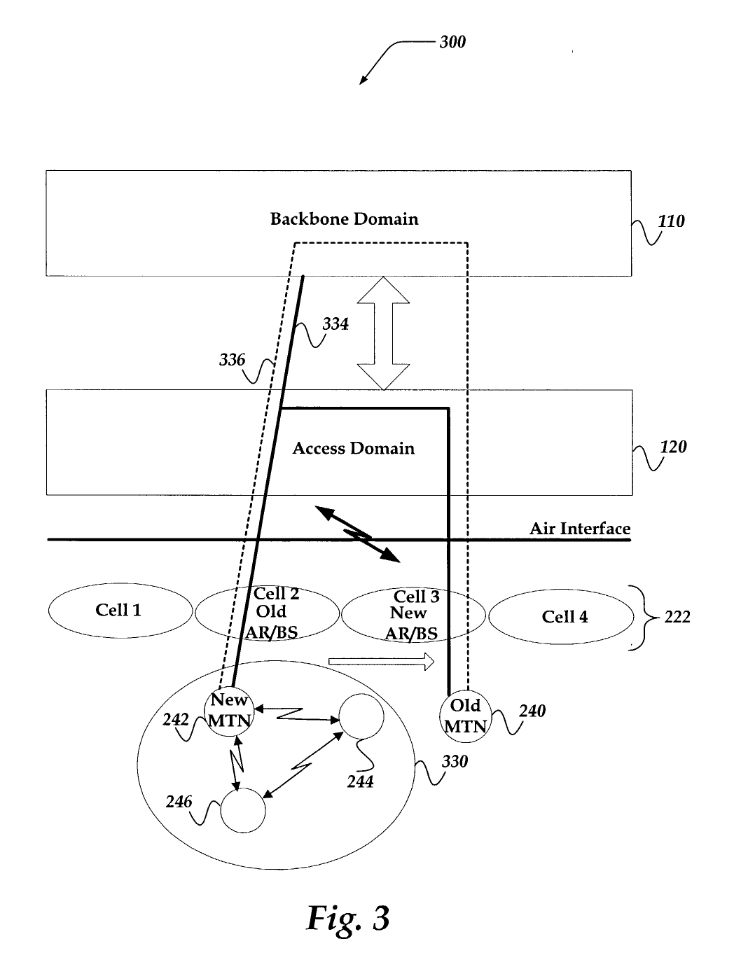

FIGS. 2-3 illustrate an Inter AR/BS Handover, as described above. Shown in FIG. 2 is a functional block diagram of one embodiment of the mobile mesh Ad-Hoc network of FIG. 1 employing a Mobile Trunk Node (MTN) prior to reverse handover, within a cellular network.

As shown in FIG. 2, system 200 includes substantially the same components as shown in FIG. 1. In FIG. 2, Mobile Ad-Hoc network 230 includes mobile nodes 242, 244, and 246, and old mobile trunk node (MTN) 240.

Cellular network 126 of FIG. 1 has been expanded in FIG. 2 to illustrate cells 222. Cell 2 is shown to include old Access Router/Base Station (AR/BS). Also shown, cell 3 includes new Access Router/Base Station (AR/BS). The terms “old” and “new” are employed to illustrate old MTN 240 transition from cell 2 with the old AR/BS to cell 3 with the new AR/BS.

As shown in the figure, old MTN 240 is enabled to function as a relay node between access domain 120, through cells 222. Old MTN 240 associates local Ad-Hoc network 230 to access domain 120 through control signaling 226, and user communication data 224.

As old MTN 240 moves out of signal range of cell 2's AR/BS, it is determined that a handover from cell 2 to cell 3 is required. Prior to the handover, old MTN 240 performs actions to determine whether there exists at least one node within local Ad-Hoc network 230 capable of providing operator assisted Ad-Hoc support. If it is determined that a suitable mobile node exists within local Ad-Hoc network 230, old MTN 240 proceeds to transfer Trunk Node logical functions to the eligible new MTN.

Referring briefly to FIG. 3, a functional block diagram generally shows one embodiment of the mobile mesh Ad-Hoc network of FIG. 2 where the original Mobile Trunk Node has completed a reverse handover to a new Mobile Trunk Node. As shown in FIG. 3, old MTN 240 has transferred the trunk node functions to new MTN 242. Old MTN 240 has also performed a handover from cell 2's ARIBS to cell 3's AR/BS. Upon completion of the reverse handover, old MTN 240 continues to participate in ongoing local Ad-Hoc network 330 communications through the cellular infrastructure of cell 222, or through a similar multihop Ad-Hoc connection. Alternatively, even if not shown in FIG. 3, the connection between the Old MTN 240 and the Ad-Hoc network 330 may, after the handover, continue over an ad-hoc connection. For example, this ad-hoc connection may be between Old MTN 240 and existing Ad-Hoc network node 244 so that Old MTN 240 is still a part of the ad-hoc domain. It should be noticed, that the Trunk Node logical functions are also in this option transferred to the New MTN.

Generalized Operation

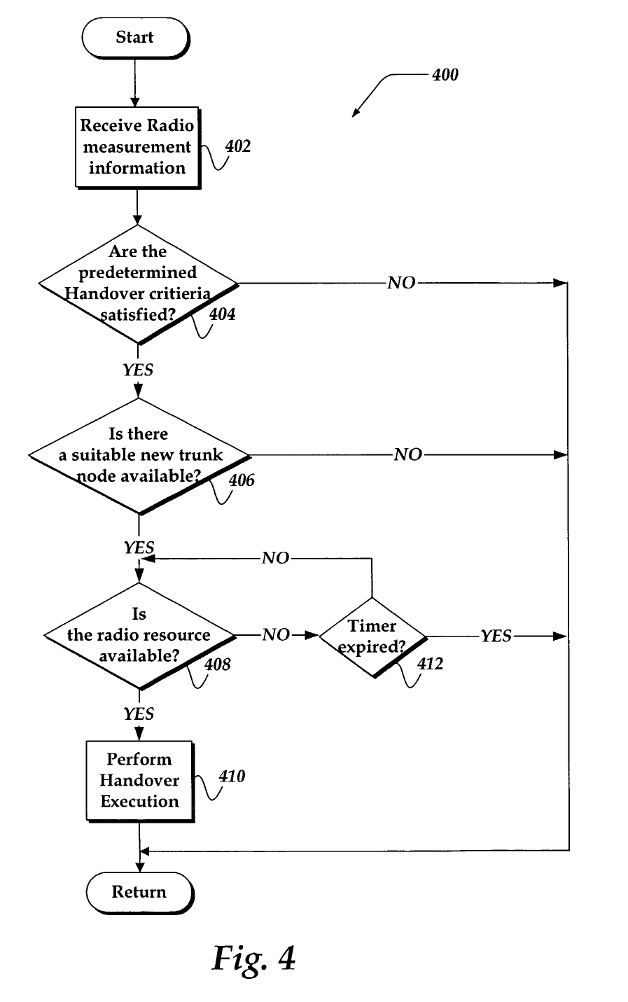

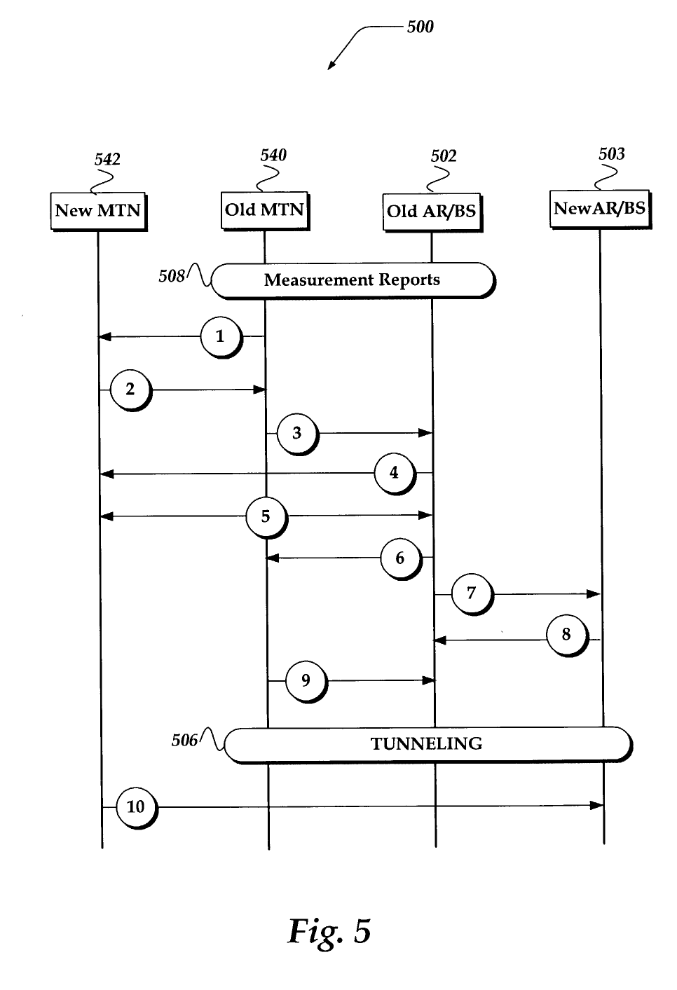

FIGS. 4-5 are flow diagrams generally showing one embodiment of a process for performing reverse handover of MTN logical responsibilities within an operator assisted mobile mesh Ad-Hoc (OAM) network, in accordance with the present invention.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

FIG. 4 is a flow diagram generally showing one embodiment of process 400 for performing reverse handovers to minimize interruption of current Ad-Hoc piggyback network traffic, in accordance with the present invention. Briefly, process 400 provides a reverse handover (RHO) to another node within a local Ad-Hoc network, such that the original merely Ad-Hoc local network connection with the original MTN is preserved when it moves to another access domain cell. Process 400 may be employed by old MTN 240 illustrated in FIGS. 2-3.

Process 400 begins, after a start block, at block 402, where radio measurement information is received by a radio resource entity, typically within a mobile trunk node within the Ad-Hoc network. The information may include service profiles and service availabilities, Quality of Services, power levels, routing metrics, signal quality, noise levels, and the like. The process proceeds next to decision block 404.

At decision block 404, a determination is made whether predetermined handover criteria are satisfied that necessitate a handover. Any of a variety of predetermined handover criteria may be employed based on the received radio measurement information, without departing from the spirit or scope of the invention. If it is determined that the predetermined handover criteria is not satisfied, then no handover is performed, and the process returns to perform other actions.

Alternatively, if at decision block 404, it is determined that the predetermined handover criteria is satisfied, the process proceeds to decision block 406. At decision block 406, a determination is made whether there is a node within the local Ad-Hoc network that is suitable as a new mobile trunk node. At the outset, to be eligible as a suitable mobile trunk node, a node within the local Ad-Hoc network should include a Subscriber Identification Module (SIM), User Identification Module (UIM), or the like. Moreover, the node must be capable of performing routing functions that establish various routes between other nodes within the local Ad-Hoc network and an operator assisted access domain. Additionally, the suitable trunk node may be selected based on criteria, such as location coordinates, movement characteristics of the node, a number of hops, a handover capability, a service profile, service availability, a Quality of Service, a power level, routing metrics, an accounting and billing policy, and the like.

If, at decision block 406, it is determined that no suitable mobile trunk node exists within the local Ad-Hoc network then a trunk node handover is not performed. The process returns to perform other actions, e.g. connecting via the backbone network or keeping connection to the TN via the ad hoc network In case the RHO cannot be successfully performed before the MTN looses connection to the access domain, the connection with access domain, earlier provided by the MTN, may be lost. Still, the ad-hoc connection may be retained. Alternatively, if, at decision block 406, it is determined that a suitable mobile trunk node exists within the local Ad-Hoc network, the process continues to decision block 408.

At decision block 408, a determination is made whether a radio resource is available. That is, is there access to a radio resource from the AR/BS that the mobile Trunk Node (MTN) is moving towards, such that a connection to the access domain may be established? In hard handovers, this determination is performed prior to allowing the MTN connection to an access domain network. In the situation of soft handovers, if there is some predetermined minimum level of radio signal quality available, the present invention determines that radio resource is available, and the connection is established.

If at decision block 408, it is determined that there is no radio resource access available, the process proceeds to decision block 412, to schedule a handover timer queue subprocess.

At decision block 412, a handover timer counts down from some predetermined time, while the old MTN continues to move out of range of the old AR/BS. In one embodiment, the predetermined time is less than about one second.

If, at decision block 412, it is determined that the handover timer is not expired, the process returns to decision block 408, where, as described above, a determination is made whether the radio resource access is available. The handover timer queue subprocess continues through block 408, and decision block 412, until it is determined that either radio resource access is available, or until the handover timer has expired.

Alternatively, if, at decision block 412, it is determined that the handover timer has expired before the radio resource access is available, then no reverse handover is performed. The AR/BS connection is lost for the old MTN, and for the local Ad-Hoc network. The process returns to perform other actions. In case the RHO cannot be successfully performed before the MTN looses connection to the access domain, the connection with access domain, earlier provided by the MTN, may even be lost. Still, the ad-hoc connection may be retained.

Alternatively, if, at decision block 408, it is determined that there is radio resource access available, the process proceeds to block 410. Block 410 is described in more detail in conjunction with FIG. 5. Briefly, however, at block 410, signals are communicated between the old MTN, the new MTN, the old AR/BS, and the new AR/BS to transfer information and perform the handover of MTN logical responsibilities to the new MTN for the local Ad-Hoc network. Moreover, the old MTN is in communication with the new AR/BS such that the old MTN may remain in communication with the local Ad-Hoc network. Upon completion of block 410, process 400 returns to perform other actions.

Reverse Handover Signal Flow

FIG. 5 is a signaling sequence diagram generally showing one embodiment of a reverse handover within an IPv6-based cellular system, in accordance with the present invention. It should be noted however, that the present invention is not limited to cellular systems. For example, the present invention may also be employed within 2G (such as GSM), and 3G (such as UMTS) mobile system architectures that are extended by an underlying Ad-Hoc layer, without departing from the scope or spirit of the invention.

As shown in FIG. 5, signals flow between old Mobile Trunk Node (MTN) 540, new MTN 542, old Access Router (AR)/Base Station (BS) 502, and new AR/BS 503. The sequence of signal flows is indicated by the numbers (1-10) on the signals. Also shown are measurement reports 508, and tunneling 506.

Signal sequence diagram 500 begins when a determination is made information obtained from measurement reports 508 that a handover may be required. These actions are substantially similar to the actions described above at blocks 402-404 of FIG. 4.

As indicated at signal flow 1 of signal sequence diagram 500, old MTN 540 communicates a handover indication or an access domain discovery signal to those nodes included in its local Ad-Hoc network, to determine whether there is a node suitable for handling the MTN logical role. In one embodiment, the signal is communicated in multicast mode within the local Ad-Hoc network.

It is assumed that old MTN 540 has already established a Care-of-Address (CoA) to the access domain. This may be achieved by employing a stateless or statefull address auto-configuration approach. This enables old MTN 540 to employ Mobile IPv6 functionalities to communicate with other nodes globally; thereby further allowing the local Ad-Hoc network under old MTN 540 to be addressed with site-local addresses, which can be bound or mapped to the corresponding global address. It is the responsibility of the old MTN 540 to advert its current Care-of-Address (CoA) to the Non-Trunk Node within the same Local Ad-Hoc network. The Non-Trunk Node employs this Routing Advertisement (or CoA) to form its own CoA and inform the corresponding old MTN to establish a binding between the CoA and the Home Address of the Non-Trunk Node. This facilitates tunneling process 506 from the Corresponding Node (CN) to the addressed Non-Trunk Node. It also allows old MTN 540 to relay data packets initiated from the backbone network to the Non-Trunk Node by mapping its own CoA, site-local address and CoA of the Non-Trunk Node.

At signal flow 2, new MTN 542 acknowledges its readiness to handle the MTN role. The acknowledge signal may also include a link layer address of new MTN 542 to allow the Non-Trunk Node to communicate with an Access Router associated with the MTN role reallocation. The actions at signal flows 1 and 2 are substantially similar to the action described above at block 406 of FIG. 4, where the MTN finds out whether there is a suitable new trunk node available.

At signal flow 3, upon ensuring that there is a valid node to carry out the MTN role, and based on the radio measurements and handover criteria (as described above in conjunction with decision blocks 404 and 408 in FIG. 4), old MTN 540 communicates a handover request/indication signal to old AR/BS 502. The request/indication signal indicates old MTN 540 is attempting to perform a handover, and move to new AR/BS 503. This may be accomplished by either the link layer, or IP layer, by employing the site-local (for multihop) and link-local addresses for the single hop Ad-Hoc network. Old MTN 540 may also communicate new MTN 542's link-local, site-local, and IP addresses to Old AR/BS 502.

At signal flow 4; old AR/BS 502 communicates a signal to new MTN 542 to set up a new connection. This communication may also include a care-of-address allocation as described above during signal flow 1. The communication may further include a link-local, site-local, IP address, and care-of-address of old MTN 540.

At signal flow 5; an authentication process is performed between old AR/BS 502 and new MTN 542, both at an Ad-Hoc network level and with respect to backbone networks, to determine whether new MTN 542 is whom it claims to be and has subscription rights.

At signal flow 6; old AR/BS 502 communicates to old MTN 540 a router advertisement informing it to which AR/BS it should attach. Although not indicated in FIG. 5, old AR/BS 502 also determines from new AR/BS 503 its resource availability for the handover execution.

At signal flow 7, old AR/BS 502 communicates a handover indication to new AR/BS 503 to provide a temporary care-of-address, the link-local, site-local, and IP addresses of old MTN 540. Old AR/BS 502 may also communicate old MTN 502's old care-of-address. It also provides the new AR/BS and IP-address reserved for uplink traffic from new AR/BS towards old AR/BS.

At signal flow 8, if it is determined that the handover criteria are met and there is available radio resource access, then new AR/BS 503 acknowledges the completion of the handover and correctness of the temporary care-of-address. It also provides the old AR/BS and IP-address reserved for downlink traffic from old AR/BS towards the new AR/BS.

At signal flow 9, Old MTN 540 requests that old AR/BS 502 setup tunneling 506 from its old care-of-address (CoA) to its new CoA. Alternatively, to optimize allocated resources, the tunneling may be established from old AR/BS 502 to the care-of-address of new MTN 542, and to the care-of-address of the old MTN 540. From the Ad-Hoc network standpoint, this means that the logical MTN role is partly transferred to old AR/BS 502 in association with the handover process, thereby enabling old AR/BS 502 to separate the Ad-Hoc and non-Ad-Hoc related traffic.

The Ad-Hoc traffic is also relayed by way of new MTN 542 to the local Ad-Hoc network. When tunneling 506 is employed, part of the network traffic may be tunneled directly to old AR/BS 502 (that is, from the old care-of-address of old MTN 540 to the care-of-address of new MTN 542), or indirectly from old-MTN 540's care-of address to new MTN 542's care-of-address by way of a new care-of-address of old MTN 540.

At signal flow 10, new MTN 542 communicates a handover completeness signal to new AR/BS 503.

Although signal sequence 500 employs a hard handover approach, it is not so limited. For example, signal sequence 500 may employ a Network Evaluated Handover (NEHO), a Mobile Evaluated Handover (MEHO) (a soft handover), or a combination, without departing from the spirit or scope of the present invention.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A system for managing handovers in a mobile network, comprising:
an access domain;
an ad-hoc domain that is in communication with the access domain, wherein the ad-hoc domain enables wireless communication with a first node operating as a mobile trunk node in the ad-hoc domain;
a first access connection that enables wireless communication between the mobile trunk node and the access domain, wherein the mobile trunk node enables other nodes in the ad-hoc domain to wirelessly communicate with the access domain; and
if the first node leaves the ad-hoc domain, handing over the operation of the mobile trunk node to a second node in the ad-hoc domain, wherein the second node operating as the mobile trunk node employs the first access connection to communicate with the access domain and enables the remaining nodes in the ad-hoc domain to wirelessly communicate with the access domain.

2. A system of claim 1, further comprising a second connection that enables the first node to wirelessly communicate with nodes operating in the ad-hoc domain by tunneling a communication path between the first node and the ad-hoc domain.

3. A system of claim 2, wherein the second connection comprises a second access connection, and wherein the tunneling is performed between the first node and the ad-hoc domain over a communication path via the first access connection and the second access connection in the access domain.

4. A system of claim 2, wherein the second connection comprises an ad-hoc connection and the tunneling is performed between the second connection and the ad-hoc domain over a communication path in the ad-hoc domain.

5. A system of claim 2, wherein the second connection comprises a second access connection and the tunneling is performed between the second connection and the ad-hoc domain over a communication path in the backbone domain.

6. The system of claim 1, wherein the second node in the ad-hoc domain is enabled to operate as the mobile trunk node based on a set of criteria, including at least one of location coordinates, movement characteristics of the nodes, number of hops, handover capability, service profile, service availability, Quality of Service, power level, routing metrics, accounting policy, billing policy and inclusion of an identifier module in the node.

7. The system of claim 1, further comprising a backbone domain that is in communication with the access domain, wherein at least a portion of the backbone domain includes an Internet infrastructure.

8. The system of claim 1, wherein the access domain includes at least one of a mesh network, Wireless Local Area Network (WLAN) and cellular network.

9. The system of claim 1, wherein at least one of the first access connection and the second access connection is a base station.

10. The system of claim 1, wherein at least one of the first access connection and the second access connection is an access point.

11. The system of claim 1, wherein the ad-hoc domain is in communication with the access domain by way of an operator assisted connection.

12. The system of claim 1, further comprising employing handover criteria to determine if the first node is leaving the ad-hoc domain, including at least one of service profile, service availability, Quality of Service, power level, routing metric, signal quality and noise level.

13. A method for managing a handover in a mobile network, comprising:
enabling a wireless communication between an ad-hoc domain and an access domain with a first node operating as a mobile trunk node in the ad-hoc domain;
accessing a first connection between the mobile trunk node and the access domain, wherein the mobile trunk node enables other nodes in the ad-hoc domain to wirelessly communicate with the access domain; and
if the first node leaves the ad-hoc domain, handing over the operation of the mobile trunk node to a second node in the ad-hoc domain, wherein the second node operating as the mobile trunk node employs the first access connection to communicate with the access domain and enables the remaining nodes in the ad-hoc domain to wirelessly communicate with the access domain.

14. A method of claim 13, further comprising employing a second connection to enable the first node to wirelessly communicate with nodes operating in the ad-hoc domain by tunneling a communication path between the first node and the ad-hoc domain.

15. A method of claim 13, wherein the second connection comprises a second access connection, and wherein the tunneling is performed between the first node and the ad-hoc domain over a communication path via the first access connection and the second access connection in the access domain.

16. A method of claim 13, wherein the second connection comprises an ad-hoc connection and the tunneling is performed between the second connection and the ad-hoc domain over a communication path in the ad-hoc domain.

17. A system of claim 13, wherein the second connection comprises a second access connection and the tunneling is performed between the second connection and the ad-hoc domain over a communication path in the backbone domain.

18. The method of claim 13, wherein the second node in the ad-hoc domain is enabled to operate as the mobile trunk node based on a set of criteria, including at least one of location coordinates, movement characteristics of at least one node, number of hops, handover capability, service profile, service availability, Quality of Service, power level, routing metrics, accounting policy, billing policy and inclusion of an identifier module in the node.

19. The method of claim 13, further comprising employing handover criteria to determine if the first node is leaving the ad-hoc domain, including at least one of service profile, service availability, Quality of Service, power level, routing metric, signal quality and noise level.

20. An apparatus for managing a handover in a mobile network, comprising:
(a) a network interface for wirelessly communicating between an ad-hoc domain and an access domain with a first node operating as a mobile trunk node in the ad-hoc domain;
(b) a transceiver for accessing a first connection between the mobile trunk node and the access domain, wherein the mobile trunk node enables other nodes in the ad-hoc domain to wirelessly communicate with the access domain; and
(c) a processor for enabling handing over the operation of the mobile trunk node to a second node in the ad-hoc domain, if the first node leaves the ad-hoc domain, wherein the second node operating as the mobile trunk node employs the first access connection to communicate with the access domain and enables the remaining nodes in the ad-hoc domain to wirelessly communicate with the access domain.

21. The apparatus of claim 20, further comprising a network interface for employing a second connection to enable the first node to wirelessly communicate with nodes operating in the ad-hoc domain by tunneling a communication path between the first node and the ad-hoc domain.

22. The apparatus of claim 20, further comprising processing means for employing at least one of radio measurement, service information and quality information to determine the criteria for handing over the operation of the mobile trunk node to the second node, said information including at least one of a service profile, service availability, Quality of Service, power level, routing metric, signal quality and noise level.

23. The apparatus of claim 21, wherein at least one of the first access connection and the second connection is a connection with a base station.

24. An method for managing a handover in an ad-hoc domain of a mobile network, comprising:
(a) communicating a handover indication signal from a first trunk node to at least one other node in the ad-hoc domain, wherein the first trunk node communicates with an access domain over a first access connection and the operation of the first trunk node enables other nodes in the ad-hoc domain to wirelessly communicate with the access domain;
(b) employing one other node in the ad-hoc domain to operate as a second trunk node;
(c) if the first trunk node leaves the ad-hoc domain, performing a handover from the first trunk node to the second trunk node, wherein the second trunk node communicates with the access domain over the first access connection with the access domain; and
(d) employing the operation of the second trunk node to enable the remaining nodes in the ad-hoc domain to wirelessly communicate with the access domain.

25. The method of claim 24, further comprising authenticating the second trunk node.

26. The method of claim 24, further comprising employing a second connection to the access domain that enables the first node to wirelessly communicate with nodes operating in the ad-hoc domain by tunneling a communication path between the first node and the ad-hoc domain.

27. The method of claim 24, further comprising communicating a trunk node role readiness acknowledgement from at least one node within the ad-hoc domain.

28. The method of claim 25, wherein employing one node from within the ad-hoc domain to operate as the second trunk node further comprises selecting the second trunk node based on a set of criteria, including at least one of location coordinates, movement characteristics of at least one node, number of hops, handover capability, service profile, service availability, Quality of Service, power level, routing metrics, accounting policy, billing policy and an identifier included in at least one node.

29. A method for managing handovers in a mobile network, comprising:
(a) analyzing radio measurement information to determine if handover criteria are fulfilled for a first mobile trunk node that is leaving an ad-hoc domain, wherein the first mobile trunk node enables other nodes in the ad-hoc domain to communicate with the access domain;
(c) analyzing radio resource information to select one node in the ad-hoc domain to operate as a second mobile trunk node; and
(d) performing a handover between a first access connection and a second access connection in communication with an access domain, wherein the selected second mobile trunk node operates trunk node logical functionality from the first mobile trunk node.

30. The method of claim 29, wherein performing the handover further comprises establishing a tunnel between the first access connection within the access domain and a care of address of the second mobile trunk node, wherein ad-hoc network traffic and non ad-hoc network traffic is separated.

31. A computer readable medium that includes executable instructions for performing actions, comprising:
(a) enabling a wireless communication between an ad-hoc domain and an access domain with a first node operating as a mobile trunk node in the ad-hoc domain;
(b) accessing a first connection between the mobile trunk node and the access domain, wherein the mobile trunk node enables other nodes in the ad-hoc domain to wirelessly communicate with the access domain; and
(c) if the first node leaves the ad-hoc domain, handing over the operation of the mobile trunk node to a second node in the ad-hoc domain, wherein the second node operating as the mobile trunk node employs the first access connection to communicate with the access domain and enables the remaining nodes in the ad-hoc domain to wirelessly communicate with the access domain.

32. A computer readable medium of claim 31 employing a second connection to enable the first node to wirelessly communicate with nodes operating in the ad-hoc domain by tunneling a communication path between the first node and the ad-hoc domain.
